(19) United States
(12) Patent Application Publication
(10) Pub. No.: US 2012/0297844 A1
(43) Pub. Date: Nov. 29, 2012

(54) KEY WITH A DECORATIVE HEAD OR BOW, WHERE THE DECORATION CAN TAKE THE SHAPE OF ANY FIGURATIVE FEATURE

(75) Inventor: Zhao Zhengbin, Gympie (AU)

(73) Assignee: SPORTY KEYS PTY LTD, Gympie, Queensland (AU)

(21) Appl. No.: 13/516,285

(22) PCT Filed: Feb. 19, 2010
(86) PCT No.: PCT/AU2010/000192

§ 371 Date: Aug. 10, 2012

(30) Foreign Application Priority Data
Dec. 15, 2009 (AU) 2009906098

(51) Int. Cl. E05B 19/04; E05B 19/00

(52) U.S. Cl. 70/402

(57) ABSTRACT

The invention is concerned with a key of which a head portion is moulded to have one or more integral figurative elements.

### FIELD OF THE INVENTION

This invention relates generally to a key and more particularly is concerned with a key which has one or more unique identifiers. Whilst the invention may be applied to a range of interests for convenience sake it shall be described herein in terms of an aid based on a user's sporting interests

### BACKGROUND TO THE INVENTION

A typical key design includes a head portion and a shaft portion which extends from the head portion. The shaft portion may be dimensioned so that only particular keys having a particular shaft profile can be used with a specific range of lock types. For example, the shaft portion may have a predetermined length, thickness and width which only allow a key formation cut on a particular shaft portion to be used with a key barrel of a specific range of locks.

It is common for a number of different types of locks to be used to lock doors, gates, locks, latches or the like. In the interest of security each lock is made to be unlocked with a particular type of key having a particular key formation and predetermined dimensions. As a result, unlocking these locks requires a different key for each lock so a person wanting to remove any of these locks often has to carry a number of keys with him or her to unlock the locks when required. It may happen, that the user may struggle to identify and use the correct key with the correct lock so that, as often happens, the user has to try a number of different keys before the correct key is sourced from the bunch of keys carried by the user before opening the particular lock with a correct key.

A number of techniques have been devised to assist a user in identifying a correct key for a particular lock. For example, keys have been coloured differently thereby assisting the user in picking the correct key for a lock which the user wants to open. Ordinarily a paint having a particular colour is applied to an outer surface of the key. However, over time the use of the key could result in the paint applied to the outer surface of the key being worn away which could make it difficult to assess the colour of the key. Furthermore, the colour of a key may not be readily recognisable in certain ambient conditions such as in different light conditions, for example at night or under a fluorescent light when compared to an incandescent light.

Although painting a key to have a particular colour may assist a user in identifying the correct key for a lock, the recognition by the user of the correct key requires the user to recall the association of the correct colour with the particular lock. For example, when faced with a number of keys all having different colours, the user may struggle to remember why the correct key is blue, green or red key. Consequently, the use of coloured keys may make it difficult for the user to associate the correct key with a particular lock.

### SUMMARY OF THE INVENTION

Accordingly, the present invention aims to overcome or to at least substantially ameliorate one or more of the disadvantages of the prior art.

In accordance with the present invention, there is generally provided for a key which includes a body having a head unit and a shaft portion which extends from the head unit, the head unit including a support portion and a shaped portion which is carried by the support portion; and wherein the shaped portion includes at least one integral figurative element; and wherein the at least one integral figurative element formed by a combination of at least a circumferential external shape of the shaped portion, a pattern formed on the shaped portion, and a colouring which applied to at least part of the shaped portion.

The product of the present invention provides a key having a head unit which is shaped to contain a distinctive character or characteristic which increases the likelihood of a user of the key being able to readily identify the key and to match a key to a correct lock.

In accordance with the present invention, there is generally provided for a key which includes a body having a head unit and a shaft portion which extends from the head unit, the head unit including a support portion and a shaped portion which is carried by the support portion; and wherein the shaped portion includes at least one integral figurative element.

In one example of the invention, the support portion may be such that it forms a base for the shaped portion. In a different example of the invention, the shaped portion is formed onto the support portion using material of the support portion or from a different material. The shaped portion, once formed onto the support portion, is capable of being gripped by a user of the key.

The body may have a key formation which is cut into the shaft portion of the body or may be a blank key so that a key formation can later be cut into the shaft portion.

The body may be manufactured from any suitable material such as a metal, a metal alloy or a suitable plastic.

The head unit may be manufactured from an integral piece of material or may be constructed from a number of different types of material. In one example of the invention, the support portion is manufactured from the same type of material as is the shaft portion. The support portion may be integrally formed with the shaft portion or may be secured to the shaft portion using any suitable technique such as welding, riveting, gluing or the like. The shaped portion also may be manufactured from the same type of material as is the shaft portion, or as the support portion, and may be fitted to the support portion to form the head unit. For example, the shaped portion may be fitted to the support portion before the support portion is connected to the shaft portion or after the support portion is fitted to the shaft portion. In another example, the shaped portion may be fitted to the support portion before the shaped portion is formed with at least one integral figurative element. In a further example, the forming of the shaped portion with the at least one integral figurative element may also cause the shaped portion to be secured to the support portion.

In one example of the invention, the shaped portion is formed onto the support portion by way of a moulding process using a suitable plastics material. The plastics material may be PVC which is formed heated and thereafter allowed cure in a suitable mould. In one example of the invention, the plastic being used to form the shaped portion is a thermoplastic which may be PVC.

The at least one integral figurative element is includes any one or a combination of the following features: a shape, a colour, and a profile. In one example of the invention, the shaped portion includes an outer section which extends around a periphery of the and a first surface and a second surface; and wherein the at least one integral figurative element is formed by a combination of two or more features of the outer section and the first and second surfaces which are selected from any one or a combination of the following: a shape, a colour, and a profile.

The at least one integral figurative element of the shaped portion may be formed using any suitable process or a combination of process. In one example, the at least one figurative element is formed by deforming at least part of an outer surface of the shaped portion. Alternatively, the shaped portion may be formed onto the support portion using any suitable process such as an injection moulding process. In a further example, the shaped portion may be constructed from two or more parts which are joined to each other to form the shaped portion around the support portion.

The at least one figurative element may include a distinctive pattern which forms the shaped portion with a distinctive character or characteristic. In one example of the invention, the distinctive pattern may include in combination with a three-dimensional profile one or more colours which are applied to predetermined areas of the shaped portion thereby to differentiate the predetermined areas from the remainder of the shaped portion.

In accordance with the present invention provides a key which includes a blank body having a support portion and a shaft portion which extends from the support portion, and the key further including an shaped portion which substantially encloses the support portion of the blank body and which allows protrusion of the shaft portion from the support portion; wherein the shaped portion includes at least one integral figurative element; and wherein the shaft portion is capable of being shaped to include a predetermined key formation required to unlock an unique lock combination.

The shaped portion of the key can include an integral figurative element having a distinctive circumferential external shape forming a distinctive character or characteristic.

The circumferential external shape can form a distinctive element related to a sport.

The distinctive element can include a person's head shape.

The distinctive element can include a person's head apparel such as a football helmet.

The distinctive element can include a sporting article such as a basketball or football.

The distinctive external shape can include lateral shape variations relative to the substantially planar parallel surfaces of the shaped portion of the key blank.

The shaped portion of the key can include an integral figurative element having a distinctive pattern forming a distinctive character or characteristic.

The distinctive pattern can be aided by different colours.

The distinctive pattern can be aided by linear surface separation. The linear surface separation can be an etched surface or a linear surface provided by the mould.

In accordance with one particularly preferred form of the invention there is provided a key comprising a blank body having a support portion and a shaft portion, and the key further including an shaped portion which substantially encloses the support portion of the blank body and which allows protrusion of the shaft portion from the support portion; wherein the head includes at least one integral figurative element formed by a combination of at least a circumferential external shape, a pattern formed thereon, and a colouring to form the integral figurative element with a distinctive character or characteristic; wherein at least one of the circumferential external shape, the pattern, and the colouring is formed in an moulding process; and wherein the shaft portion is capable of being shaped to provide the shaft portion with a unique lock combination.

The circumferential external shape can form a distinctive element related to a sport.

The distinctive element can include a person's head shape.

The distinctive element can include a person's head apparel such as a football helmet.

The distinctive element can include a sporting article such as a basketball or football.

The distinctive external shape can include lateral shape variations relative to the substantially planar parallel surfaces of the head of the key blank.

Also according to an aspect of the invention there is provided a method of forming a head unit of a key, the method including the steps of:
providing a key body having a support portion and a shaft portion;
providing a mould sized to receive at least a substantial portion of the support portion of the key body;
inserting mouldable material into the mould;
forming the head unit by forming a shaped portion onto the support portion and which includes at least one integral figurative element which is formed by a combination of at least a circumferential external shape, a pattern, and a colouring;
and wherein at least one of the circumferential external shape, the pattern, and the colouring is formed during the formation of the shaped portion.

The shaped portion may be formed from thermoplastic such as PVC.

In a particular form of the invention, there is generally provided a method of forming head unit of a key, the method including the steps of:
forming a mould for a shaped portion of the head unit and which includes at least one integral figurative element formed by a combination of at least a circumferential external shape, a pattern, and a colouring;
inserting coloured liquid PVC into the mould;
applying heat to the mould thereby melting the PVC;
allowing the melted PVC to cure;
the insertion of coloured liquid PVC and heating to set as required;
inserting key blank head;
completing overmould by insertion of liquid PVC and heating to set thereby forming a key comprising a blank having a head and a shaft body, and the key further including an overmoulded head substantially encompassing the head of the blank and allowing protrusion of the shaft body;

The invention aims to overcome at least some of the problems of the prior art by providing keys which might be more readily identifiable due to combination of colour, circumferential shape and pattern. Also these keys are more likely to be resistant to damage.

### BRIEF DESCRIPTION OF THE DRAWINGS

In order that the invention can be more readily understood an embodiment of the invention will be now described by way of an example with reference to the drawings wherein:

FIG. 1 is a schematic illustration of a key in accordance with the invention a shaped section of a head unit of the key has been shaped to have one example of an integral figurative element;

FIGS. 2 and 3 are respectively an end view and a side view of the key of FIG. 1 showing a support portion and a shaft portion of the key;

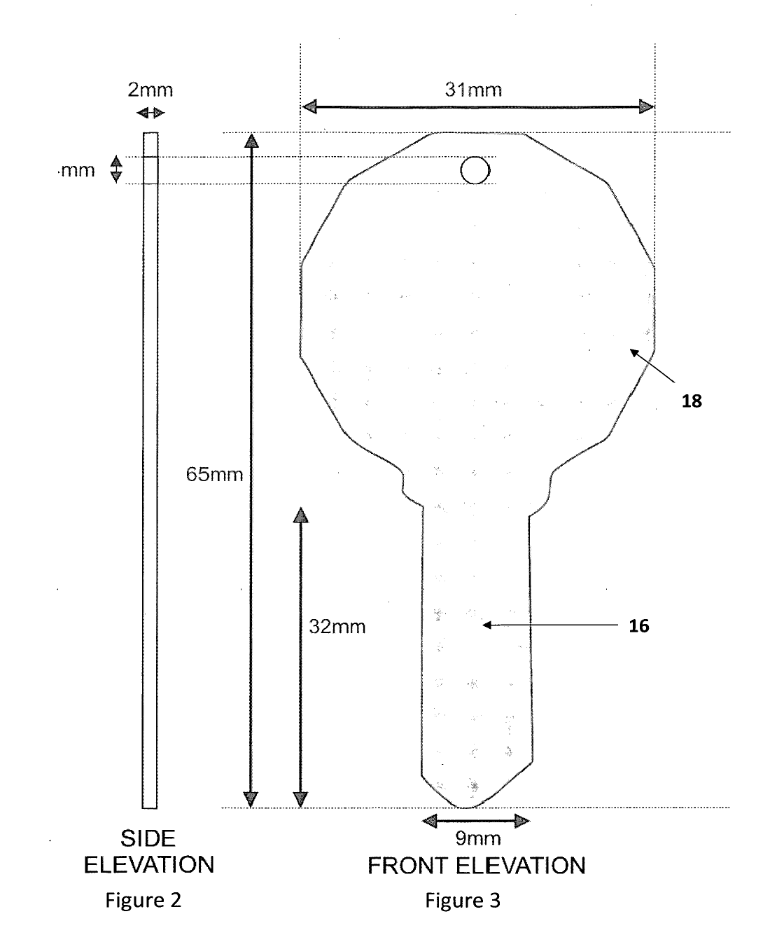

FIGS. 4 and 5 are schematic representations showing the key of FIG. 3 carrying a shaped portion which has an integral figurative element which is different to the shaped portion shown in FIG. 1; and

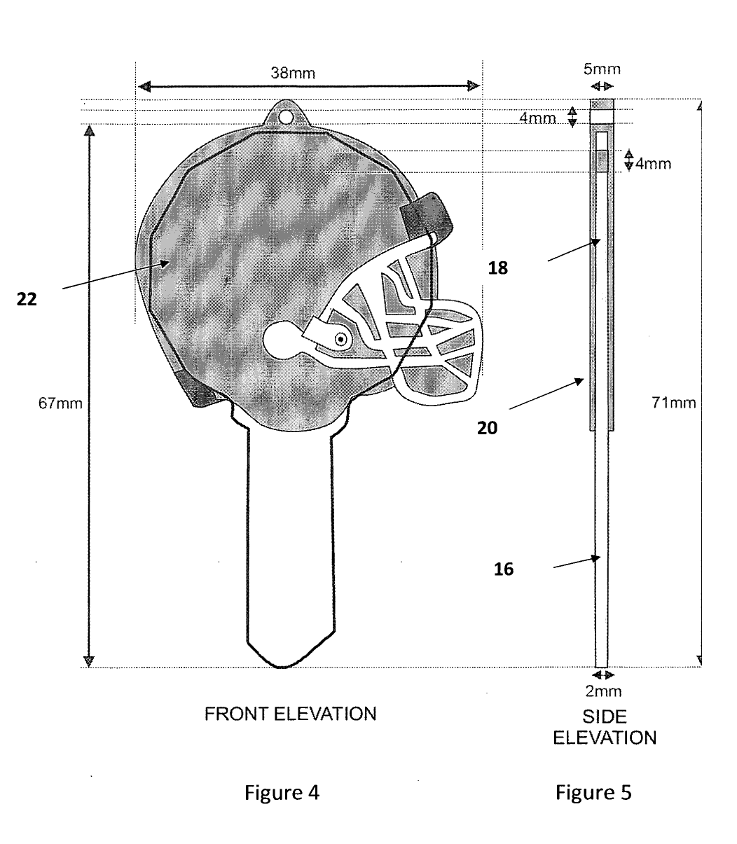

FIG. 6 is a schematic view of the key of FIGS. 4 and 5 of which the shaped portion includes a further figurative element.

### DESCRIPTION OF AN ILLUSTRATED EMBODIMENT OF THE INVENTION

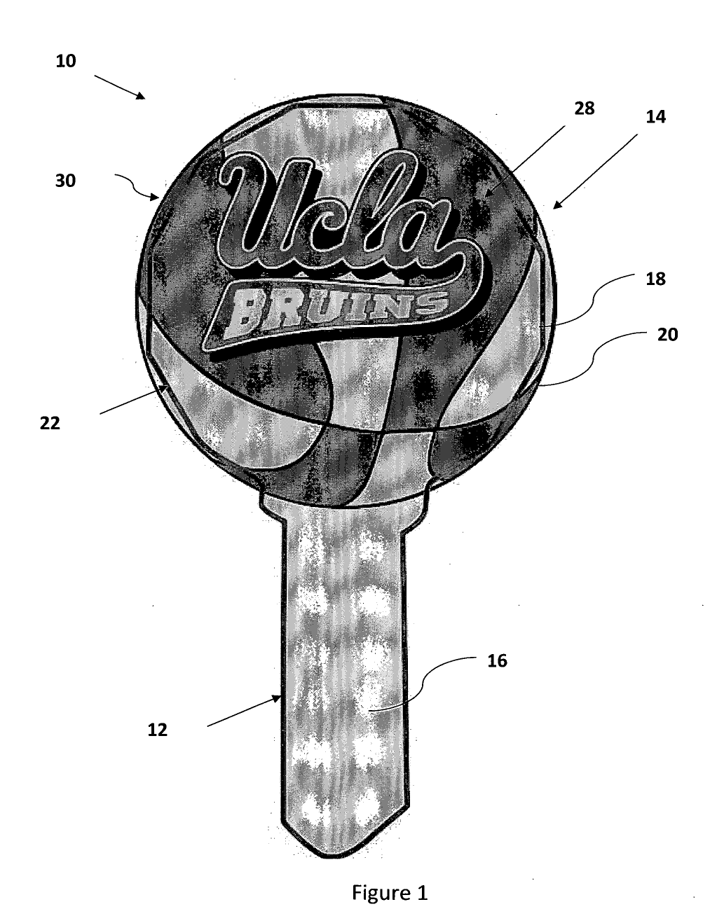

FIG. 1 of the accompanying drawings illustrate a key 10 in accordance with the invention which includes a body 12 which has a head unit 14 and a shaft portion 16.

The head unit 14 has a support portion 18 which carries a shaped portion 20. The shaped portion is formed in a moulding process in which a thermoplastic such as PVC is used to manufacture the shaped portion onto the support portion. The shaped portion allows the shaft portion to protrude or extend from the support portion while the shaped portion is moulded onto the support portion.

The shaped portion 18 includes at least one integral figurative element 22 which is formed by a combination of at least a circumferential external shape, a pattern, and a colouring which, in combination, give the at least one integral figurative element a distinctive character or characteristic.

In FIG. 1 the figurative element 22 is a basketball formed of an outside shape and an inner design of different lines of a basketball and a combination of contrasting colours. Over the basketball design is a basketball team insignia. The shaped portion 20 has an end surface 24 which extends around a periphery 26 of the shaped portion, and a first surface 28 on one side of the shaped portion and a second, opposed surface 30 on another side of the shaped portion. The distinct characteristic of the integral figurative element is established by the shape of the end surface in combination with the shape, pattern, or colouring of the first and second surfaces.

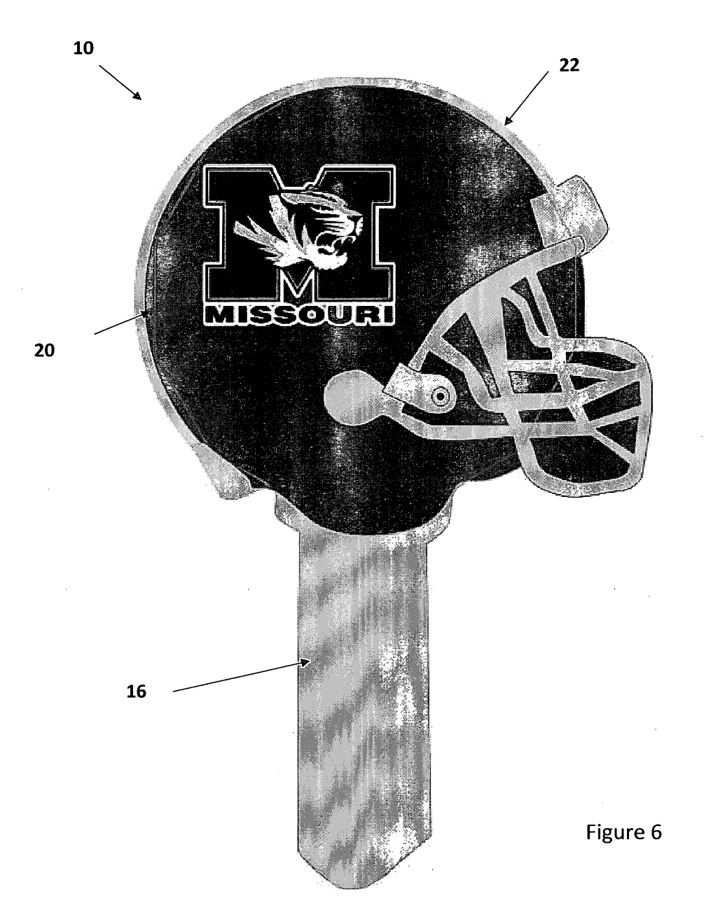

In FIG. 6 the figurative element is a US college footballer's helmet formed of an outside shape and an inner design of different lines of a college footballer's helmet and a combination of contrasting colours. Over the college footballer's helmet design is a college football team insignia

The distinctive circumferential external shape, the distinctive pattern formed thereon, and the distinctive colouring are formed in a moulding process. In construction the key is formed of two parts being the metallic key part, which consists of the shaft portion 16 and the support portion 18, and the shaped portion 20 which is formed from PVC. During production the PVC is firstly in a liquid state, the head of the key blank is then buried/immersed fully in the PVC which is then heated and hardened in a mould. The mould has designs in outer shape both circumferentially and texturally thereover such that when the key is removed from the mould it has the required distinctive character or characteristic.

The moulding material is a type of PVC that makes it flexible, soft and tactile. PVC (Polyvinylchloride) is a single-element substance. To make it flexible, soft and tactile, a softener is added. The PVC mould and softener can be a product called Polyol Benzoate (DEDB).

The process for including different colours is undertaken in different steps during moulding. Colours are hand-filled during moulding—one colour each step. The coloured PVC liquid is dropped into each recess on the mould, then heated to make it solidify. Each colour needs to be heated before filling the second colour. The backing black portion can be different to the front figurative part. However the backing portion does not have to be black, it can be any colour. This is just the last colour fill dropped over the previous colours being the front figurative parts.

It can be seen that the invention provides a new decorative, functional and advertising article which also provides an improved usage to the key by allowing ready recognition of a key merely by touch to The key is provided by a novel construction method that allows the at least one and preferably all three of the distinctive circumferential external shape, the distinctive pattern formed thereon, and the distinctive colouring to be formed in an overmoulding process.

This moulding of shapes is different to moulding of particular keys such as car keys that have moulded shapes. Those regular keys with moulded shapes are made of plastic (ABS), which is mould-casted using casting machines. The present invention having a PVC key is also a much more durable key and will overcome the shortcomings of the current keys painted keys.

While we have described herein a particular embodiment of a key, it is further envisaged that other embodiments of the invention could exhibit any number and combination of any one of the features previously described. However, it is to be understood that any variations and modifications can be made without departing from the spirit and scope thereof.

For example the shapes and pictures that can be made in this process is unlimited. Patterns and shapes can be on one side or both sides of the key. Also sports can be related to any sport such as college football helmet or NFL™, NCAA™ football helmet, and NCAA™ basketball, NBA™ basketball and many other sports and other interests.

1. A key which includes a body having a head unit and a shaft portion which extends from the head unit, the head unit including a support portion and a shaped portion which is carried by the support portion; and wherein the shaped portion includes at least one integral figurative element.

2. A key according to claim 1 wherein the support portion and the shaped portion are manufactured from an integral piece of material.

3. A key according to claim 1 wherein the support portion and the shaped portion are manufactured from different types of material.

4. A key according to claim 3 wherein the support portion is formed integrally with the shaft portion; and wherein the shaped portion is formed onto the support portion.

5. A key according to claim 4 wherein the shaped portion is formed onto the support portion with a moulding process in which the shaped portion is manufactured from a suitable plastic.

6. A key according to claim 5 wherein the plastic is a thermoplastic.

7. A key according to claim 6 wherein the thermoplastic is PVC.

8. A key according to any one of claims 1 to 6 wherein the at least one integral figurative element is includes any one or a combination of the following features: a shape, a colour, and a profile.

9. A key according to claim 8 wherein the shaped portion includes an outer section which extends around a periphery of the and a first surface and a second surface; and wherein the at least one integral figurative element is formed by a combination of two or more features of the outer section and the first and second surfaces which are selected from any one or a combination of the following: a shape, a colour, and a profile.

10. A key which includes a blank body having a support portion and a shaft portion which extends from the support portion, and the key further including an shaped portion which substantially encloses the support portion of the blank body and which allows protrusion of the shaft portion from the support portion; and wherein the shaped portion includes at least one integral figurative element; and wherein the shaft portion is capable of being shaped to include a predetermined key formation required to unlock an unique lock combination.

11. A key which includes a body having a head unit and a shaft portion which extends from the head unit, the head unit including a support portion and a shaped portion which is carried by the support portion; and wherein the shaped portion includes at least one integral figurative element; and wherein the at least one integral figurative element formed by a combination of at least a circumferential external shape of the shaped portion, a pattern formed on the shaped portion, and a colouring which applied to at least part of the shaped portion.

12. A key comprising a blank body having a support portion and a shaft portion, and the key further including an shaped portion which substantially encloses the support portion of the blank body and which allows protrusion of the shaft portion from the support portion; wherein the head includes at least one integral figurative element formed by a combination of at least a circumferential external shape, a pattern formed thereon, and a colouring to form the integral figurative element with a distinctive character or characteristic; wherein at least one of the circumferential external shape, the pattern, and the colouring is formed in an moulding process; and wherein the shaft portion is capable of being shaped to provide the shaft portion with a unique lock combination.

13. A key according to claim 12 wherein the circumferential external shape is a distinctive element related to a sport.

14. A key according to claim 13 wherein the distinctive element includes a person's head shape.

15. A key according to claim 14 wherein the distinctive element includes a person's head apparel such as a football helmet.

16. A method of forming a head unit of a key, the method including the steps of:
providing a key body having a support portion and a shaft portion;
providing a mould sized to receive at least a substantial portion of the support portion of the key body;
inserting mouldable material into the mould;
forming the head unit by forming a shaped portion onto the support portion and which includes at least one integral figurative element which is formed by a combination of at least a circumferential external shape, a pattern, and a colouring;
and wherein at least one of the circumferential external shape, the pattern, and the colouring is formed during the formation of the shaped portion.

17. A method of forming head unit of a key, the method including the steps of:
forming a mould for a shaped portion of the head unit and which includes at least one integral figurative element formed by a combination of at least a circumferential external shape, a pattern, and a colouring;
inserting coloured liquid PVC into the mould;
applying heat to the mould thereby melting the PVC;
allowing the melted PVC to cure; the insertion of coloured liquid PVC and heating to set as required;
inserting key blank head;
completing overmould by insertion of liquid PVC and heating to set thereby forming a key comprising a blank having a head and a shaft body, and the key further including an overmoulded head substantially encompassing the head of the blank and allowing protrusion of the shaft body.
